(19) United States
(12) Patent Application Publication
(10) Pub. No.: US 2025/0330264 A1
(43) Pub. Date: Oct. 23, 2025

(54) MIXED SCHEME FOR ACCURATE APPROXIMATIONS IN CONSTELLATION SHAPING

(71) Applicant: QUALCOMM Incorporated, San Diego, CA (US)

(72) Inventors: Wei LIU, Beijing (CN); Thomas Joseph RICHARDSON, South Orange, NJ (US); Changlong XU, Beijing (CN); Liangming WU, Beijing (CN); Hao XU, Beijing (CN)

(21) Appl. No.: 18/864,929

(22) PCT Filed: Aug. 1, 2022
(86) PCT No.: PCT/CN2022/109403

§ 371 Date: Nov. 12, 2024

(51) Int. Cl. H04L 1/00

(52) U.S. Cl. CPC H04L 1/0042

(57) ABSTRACT

Certain aspects of the present disclosure provide a method for wireless communications. The method generally includes obtaining a sequence device of information bits, applying a shaper algorithm to the sequence of information bits to generate a sequence of shaped symbols, wherein the shaper algorithm involves at least one parameter that indicates a quantity of symbol sequences that satisfies an energy constraint and further wherein the application of the shaper algorithm comprises determining, for a given energy value and a symbol sequence length, whether to use an approximation or a stored value of the at least one parameter, and outputting the sequence of shaped symbols for transmission.

### BACKGROUND

### Field of the Disclosure

Aspects of the present disclosure relate to wireless communications, and more particularly, to techniques for wireless transmission.

### Description of Related Art

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available wireless communication system resources with those users.

Although wireless communication systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communication systems, increasing the ability for different types of devices to intercommunicate, increasing the number and type of wireless communication mediums available for use, and the like. Consequently, there exists a need for further improvements in wireless communications systems to overcome the aforementioned technical challenges and others.

### SUMMARY

One aspect provides a method of wireless communication at a first wireless device. The method generally includes obtaining a sequence of information bits, applying a shaper algorithm to the sequence of information bits to generate a sequence of shaped symbols, wherein the shaper algorithm involves at least one parameter that indicates a quantity of symbol sequences that satisfies an energy constraint and further wherein the application of the shaper algorithm comprises determining, for a given energy value and a symbol sequence length, whether to use an approximation or a stored value of the at least one parameter, and outputting the sequence of shaped symbols for transmission to a second wireless device.

One aspect provides a method of wireless communication at a second wireless device. The method generally includes obtaining a sequence of shaped symbols from a first wireless device and applying a deshaper algorithm to the sequence of shaped symbols to recover a sequence of information bits, wherein the deshaper algorithm involves at least one parameter that indicates a quantity of symbol sequences that satisfies an energy constraint and further wherein the application of the deshaper algorithm comprises determining, for a given energy value and a symbol sequence length, whether to use an approximation or a stored value of the at least one parameter.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communication network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communication network.

FIG. 5 depicts an example implementation of a transmitter and receiver.

FIG. 6 depicts an example mapping of bit sequences to symbol sequences.

FIG. 7A and FIG. 7B depict example plots of quantities of symbol sequences of a given sequence length that satisfy an energy constraint.

FIG. 8 depicts an example of numerical inaccuracy in approximating the quantity plotted in FIG. 7A.

FIG. 9 and FIG. 10 depict example regions, for pairs of symbol sequence lengths and energy values, where actual values may be stored for the quantities plotted in FIGS. 7A and 7B, in accordance with aspects of the present disclosure.

FIG. 11 depicts a method for wireless communications.

FIG. 12 depicts a method for wireless communications.

FIG. 13 depicts aspects of an example communications device.

### DETAILED DESCRIPTION

Aspects of the present disclosure provide apparatuses, methods, processing systems, and computer-readable mediums for wireless transmission. In particular, techniques presented herein provide enhancements to wireless transmission schemes that involve distribution matching (DM).

Communication over a channel is possible if the transmission rate over the channel satisfies a capacity based on the transmission power and the signal-to-noise ratio (SNR). The Shannon Capacity refers to a theorem that defines a maximum amount of information that can be transmitted over a channel (e.g. a wireless channel). Traditionally used coded modulation (CM) techniques, such as amplitude shift keying (ASK) and quadrature amplitude modulation (QAM), have signal constellations that are characterized by equidistant signal points and uniform signaling (e.g., a non-Gaussian distribution of information), meaning each signal point is transmitted with a same probability. Unfortunately, uniform signaling may optimistically achieve an achievable information rate (AIR) that is 1.53 dB (0.255 bits per dimension (bit/1-D)) away from the capacity of an analog white Gaussian noise (AWGN) channel (sometimes referred to as the “shaping gap”).

To close the shaping gap and to increase spectral efficiency, signal shaping techniques may be applied to generate a non-uniform distribution of the information. For example, in geometric shaping, constellation points are arranged in the complex plane in a non-equidistant manner to mimic a capacity achieving distribution. Probabilistic shaping, on the other hand, starts with a constellation with equidistant signal points (e.g., ASK or QAM) but assigns different probabilities to different constellation points.

Examples of probabilistic shaping including trellis shaping and shell mapping. Probabilistic amplitude shaping (PAS) is another technique for employing probabilistic shaping that has achieved high throughput for commercial use in optical core networks (e.g., over 10 GB/second). Probabilistic shaping offers low-complexity and flexible integration with existing coding schemes. PAS generally provides low-complexity integration of amplitude shaping into existing binary forward error correction (FEC) systems and large shaping gain and inherent rate adaptation functionality.

In some cases, PAS based transmitters may perform additional processing to increase spectral efficiency. For example, in a variable-to-fixed distribution matching scheme, a PAS based transmitter may perform processing to identify a number of information bits that can likely be received successfully at the receiver (by emulating receiver-side processing at the transmitter), in order to avoid transmitting extra bits that would likely be discarded at the receiver. In this manner, the variable-to-fixed scheme may limit the amount of signaling overhead.

Aspects of the present disclosure propose enhancements to a PAS based transmission schemes. For example, certain aspects of the present disclosure allow for actual values of certain quantities used in sphere shaping schemes to be used, when approximating these quantities results in significant approximation error and/or significant processing overhead. As a result, the techniques presented herein may result in more accurate results or reduced processing complexity.

### Introduction to Wireless Communication Networks

The techniques and methods described herein may be used for various wireless communications networks. While aspects may be described herein using terminology commonly associated with 3G, 4G, and/or 5G wireless technologies, aspects of the present disclosure may likewise be applicable to other communication systems and standards not explicitly mentioned herein.

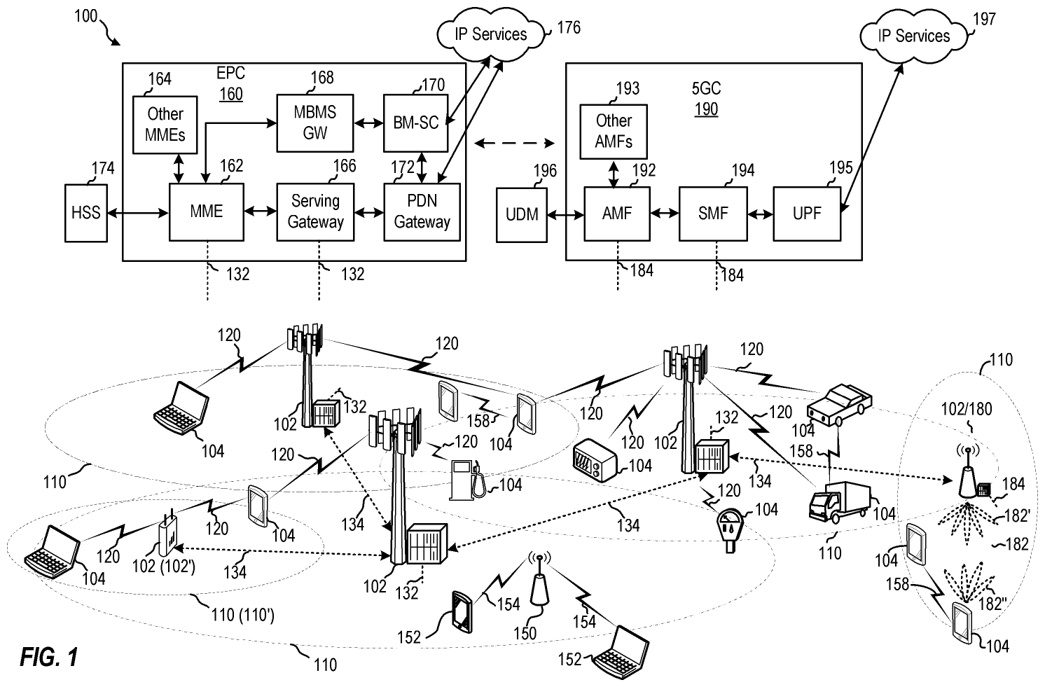

FIG. 1 depicts an example of a wireless communication network 100, in which aspects described herein may be implemented.

Generally, wireless communication network 100 includes various network entities (alternatively, network elements or network nodes). A network entity is generally a communications device and/or a communication function performed by a communications device. For example, various functions of a network as well as various devices associated with and interacting with a network may be considered network entities.

In the depicted example, wireless communication network 100 includes base stations (BSs) 102, user equipments (UEs) 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with UEs 104 via communications links 120. The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and others. Each of BSs 102 may provide communication coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communication coverage for a macro cell (covering relatively large geographic area), a pico cell (covering relatively smaller geographic area, such as a sports stadium), a femto cell (relatively smaller geographic area (e.g., a home)), and/or other types of cells.

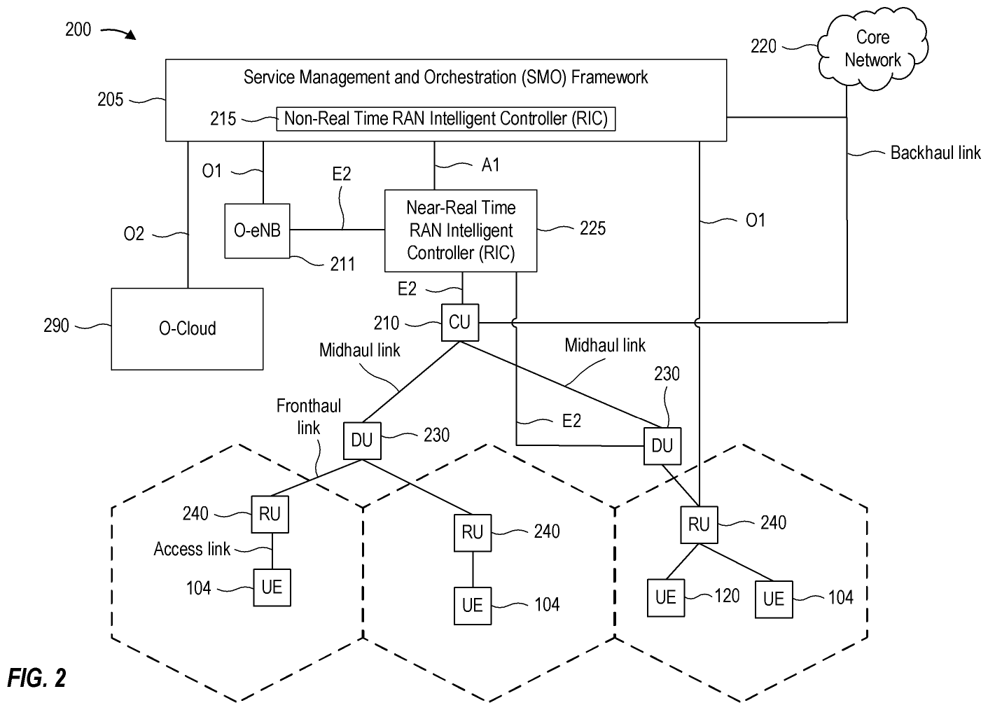

While BSs 102 are depicted in various aspects as unitary communications devices, BSs 102 may be implemented in various configurations. For example, one or more components of base station may be disaggregated, including a central unit (CU), one or more distributed units (DUs), one or more radio units (RUs), a radio unit (RU), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communication network 100 may also be configured to support different radio access technologies, such as 3G, 4G, and 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communication network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communication links 120 between BSs 102 and, for example, UEs 104, may be through one or more carriers, which may have different bandwidths (e.g., 5, 10, 15, 20, 100, 400, and other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. BS 180 may also receive the beamformed signal from UE 104 in one or more receive directions 182′. Base station 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communication network 100 further includes a Wi-Fi AP 150 in communication with Wi-Fi stations (STAs) 152 via communication links 154 in, for example, a 2.4 GHz and/or 5 GHz unlicensed frequency spectrum.

Certain UEs 104 may communicate with each other using device-to-device (D2D) communication link 158. D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172 in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/MHL models to perform corrective actions through the SMO Framework 205 (such as reconfiguration via 01) or via creation of RAN management policies (such as A1 policies).

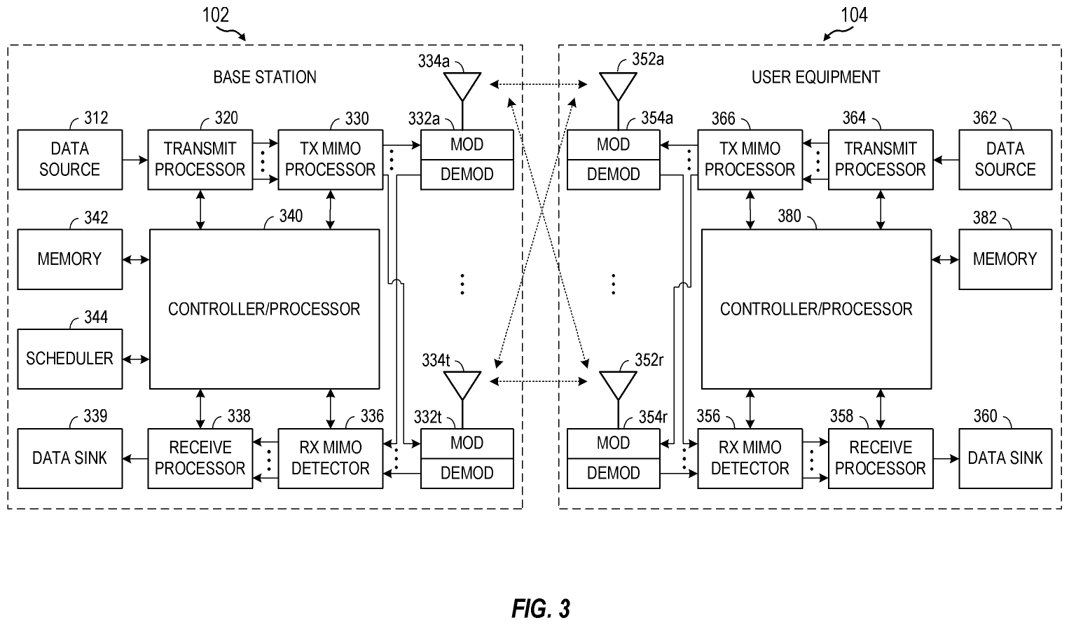

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., data source 362) and wireless reception of data (e.g., data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (Tx) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a Tx MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, Tx MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, Rx MIMO detector 336, controller/processor 340, receive processor 338, scheduler 344, memory 342, and other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, Tx MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, Rx MIMO detector 356, controller/processor 380, receive processor 358, memory 382, and other aspects described herein.

In some aspects, a processor may be configured to perform various operations, such as those associated with the methods described herein, and transmit (output) to or receive (obtain) data from another interface that is configured to transmit or receive, respectively, the data.

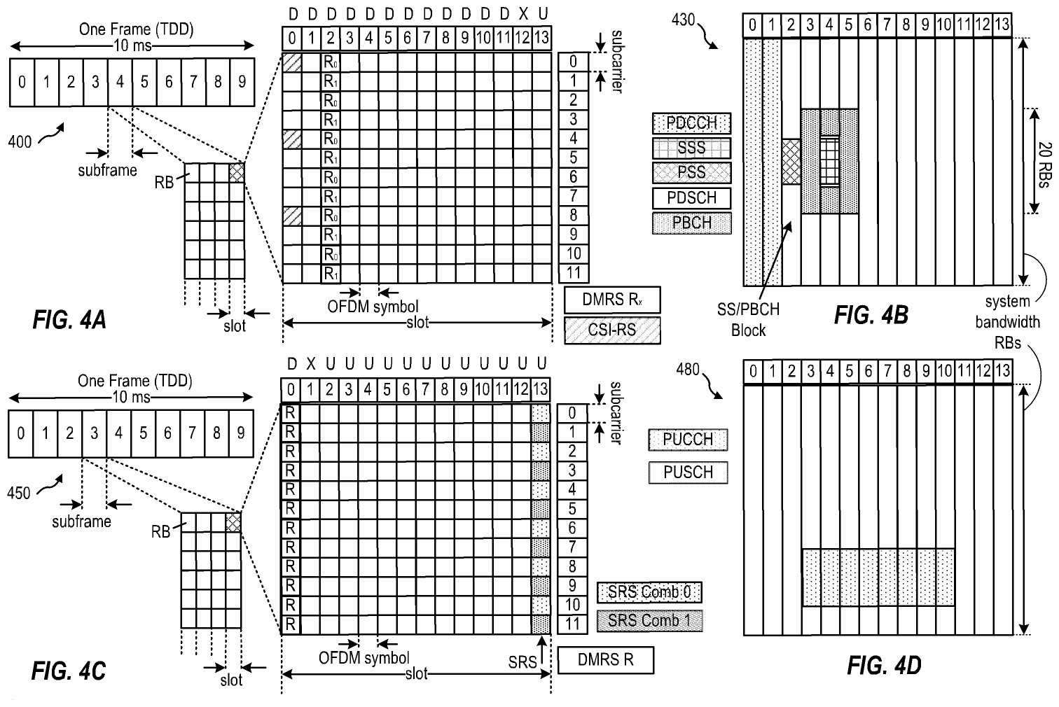

FIGS. 4A, 4B, 4C, and 4D depict aspects of data structures for a wireless communication network, such as wireless communication network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communication systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and in the time domain with SC-FDM.

A wireless communication frame structure may be frequency division duplex (FDD), in which for a particular set of subcarriers and subframes within the set of subcarriers are dedicated for either DL or UL. Wireless communication frame structures may also be time division duplex (TDD), in which for a particular set of subcarriers and subframes within the set of subcarriers are dedicated for both DL and UL.

In FIGS. 4A and 4C, the wireless communication frame structure is TDD where D is DL, U is UL, and X is flexible for use between DL/UL. UEs may be configured with the slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot configuration. Subframes may also include mini-slots, which generally have fewer symbols than an entire slot. Other wireless communication technologies may have a different frame structure and/or different channels.

Generally, the number of slots within a subframe is based on a slot configuration and a numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and channel state information reference signals (CSI-RS) for channel estimation at the UE. The RS may also include beam measurement RS (BRS), beam refinement RS (BRRS), and phase tracking RS (PT-RS).

FIG. 4B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may also transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Probabilistic Amplitude Shaping Architecture

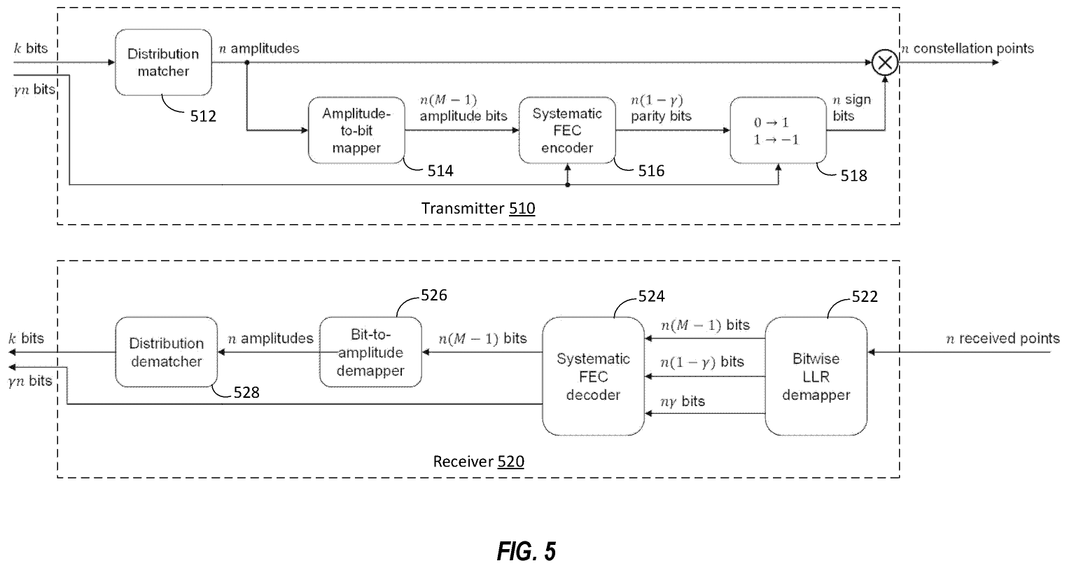

FIG. 5 illustrates a communication system employing probabilistic amplitude shaping. Probabilistic amplitude shaping (PAS) utilizes reverse concatenation whereby the shaping precedes FEC coding.

The communication system includes a wireless transmitter 510 at a first wireless device and a wireless receiver 520 at a second wireless device. The first and second wireless devices may be, for example, a UE (e.g., a UE 104 of FIG. 1) and network entity, such as a base station (e.g., a gNB 102 of FIG. 1) or node of a disaggregated base station as described with reference to FIG. 2. In some cases, both the first and second wireless device could be a UE (e.g., for sidelink scenarios).

As illustrated, the transmitter 510 essentially combines an outer layer of shaping with an inner layer of binary forward-error-correction (FEC) in order to provide a relatively low-complexity and flexible integration with existing bit-interleaved coded modulation (BICM) schemes. This transmitter 510 may provide a relatively large shaping gain and inherent rate adaptation functionality.

As illustrated, transmitter 510 takes a length-k bit sequence and γn information bits and generates a sequence of n symbols (a length-n symbol sequence). For example, symbols may be generated based on a 2^{M}-ary amplitude shifting keying (ASK) constellation {±1, +3, . . . , ±(2^{M}−1)} with amplitude alphabet [symbol] ={1, 3, . . . , 2^{M}−1}.

A distribution matcher (DM) 512 maps the length-k bit sequence to a length-n amplitude sequence. Thus, the DM rate (R_{dm}) may be given as:

$${R}_{d m} = \frac{k}{n} .$$

An amplitude to bit mapper 514 may map the length-n amplitude sequence to n(M−1) amplitude bits.

The n(M−1) amplitude bits and the γn information bits together constitute n(M−1+γ) bits as input to a systematic FEC encoder 516, which then generates n(1−γ) parity bits. Thus, the systematic forward-error-correction (FEC) code rate (R_{c}) may be given as:

$${R}_{c} = \frac{M - 1 + γ}{M} .$$

The n(1−γ) parity bits together with the γn information bits are converted to n sign bits at block 518, and are pointwise multiplied with the n amplitudes from the output of DM 512. Thus, the transmission rate (Rt) may be given as Rt=R_{dm}+γ.

As illustrated, receiver 520 may perform complementary processing. At the wireless receiver 520, the length-n symbol sequence may receive by a bitwise log-likelihood ratios (LLR) demapper 522 to demap the symbols to n(M−1) bits, n(1−γ) bits, and nγ bits. These bits are received by FEC decoder 524. The resulting n(M−1) bits are received by bit-to-amplitude demapper 526 that generates the n amplitudes. Distribution de-mapper 528 receives the n amplitudes and recovers the length-k bit sequence.

The mapping of the DM 512 may be designed to induce a non-uniform marginal distribution over the amplitude symbols {1, 3, . . . , 2^{M}−1}. The non-uniform distribution over the amplitude symbols induced by the distribution matching may be expected to be closer to the capacity-achieving distribution than the uniform distribution (e.g., being more Gaussian-like or being a Maxwell-Boltzmann distribution in an analog AWGN setting).

If the mapping is designed to achieve a Maxwell-Boltzmann (MB) distribution and shaping gain, this may result in a symmetric probability distribution of the form:

$${p}_{v} ( x ) = \frac{1}{{z}_{v}} {e}^{- v {x}^{2}} , where x ∈ \{ \pm 1 , \pm 3 , … , \pm ( {2}^{M} - 1 ) \} .$$

This mapping may induce an MB distribution for amplitudes, with a resulting shaping gain over an AWGN channel. An optimal MB-distributed input may exhibit a shaping gain, relative to (over) a uniformly distributed input over an ASK constellation. For example, this may result in a 1.243 dB shaping gain over a uniform 32 ASK (e.g., a same bits per channel per use may be obtained with a lower SNR).

### Aspects Related to a Mixed Scheme for Accurate Approximations in Constellation Shaping

Aspects of the present disclosure provide enhancements to wireless transmission schemes that involve constellation shaping, such as sphere shaping.

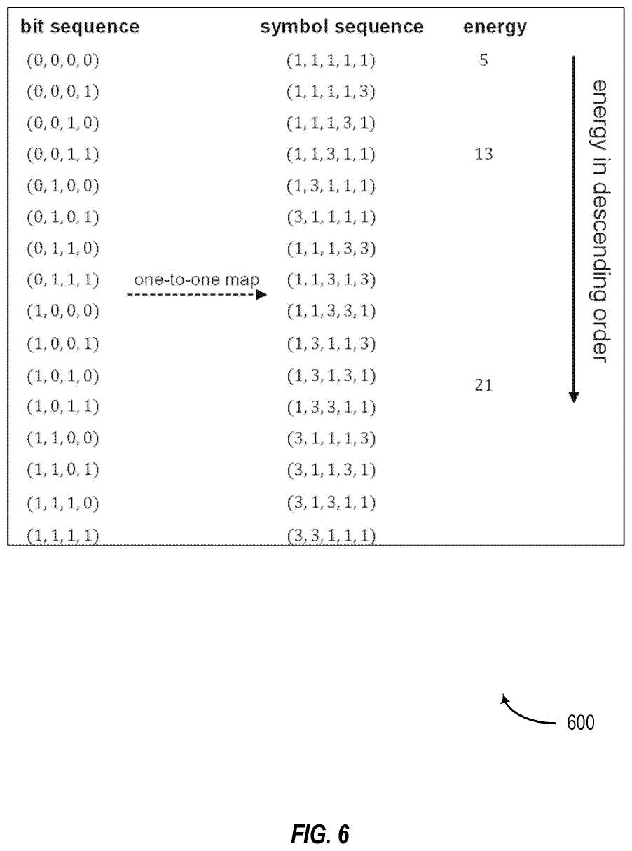

In this context, sphere shaping generally refers to a shaping scheme that considers the 2^{k} symbol sequences of length n with minimal energy. FIG. 6 illustrates an example mapping from length-k bit sequences to length-n symbol (e.g., amplitude) sequences is one-to-one. The particular mapping used in an implementation is typically dependent on an underlying method. Different shaping methods using minimal energy sequences can have different one-to-one mappings.

One potential advantage of sphere shaping is that it typically uses minimum energy sequences. The resulting marginal distribution is typically close to Maxwell-Boltzmann distribution and may have near optimal shaping gain and minimum energy use for given rate.

One potential challenge with traditional sphere shaping algorithms, however, is the potentially high computational or storage complexity. Aspects of the present disclosure, however, provide a mixed (or hybrid) scheme that may allow for an efficient use of stored values, for example, when approximating corresponding quantities results in significant approximation error or significant processing overhead. The techniques presented herein may result in more accurate results, reduced processing complexity, and efficient use of storage.

This hybrid approach may be applied to a first parameter, N_{c}(n, E), that indicates a first quantity of symbol sequences, wherein each symbol sequence of the first quantity of symbol sequences (of length n) includes symbols from a symbol alphabet and has an energy less than or equal to the given energy value (E) and/or to a second parameter, N(n, E), that indicates a second quantity of symbol sequences, wherein each symbol sequence of the second quantity of symbol sequences (of length n) includes symbols from the symbol alphabet and has an energy equal to the given energy value (E).

The concept of symbol energy may be explained with reference to a symbol alphabet [symbol] ₘ of size m, where m is an integer greater than one and [symbol] ₘ={a₁, a₂, . . . , aₘ}. In this case, an ordering may be imposed on the alphabet [symbol] ₘ, such that aᵢ<aᵢ₊₁ for each i, i.e., a₁<a₂< . . . <aₘ. In this case, the energy of a symbol aᵢ, for each i, may be denoted by E(aᵢ). As shown in FIG. 6, it may be assumed that symbol energies are distinct and may be assumed for any i∈{1, 2, . . . , m−1} that: 0≤E(aᵢ)<E(aᵢ₊₁).

Examples of symbol energy may be provided considering ASK constellations. In such cases, one example may assume that [symbol] ={1, 3, . . . , 2^{M}−1}, such that m=2^{M}−1 and {−1, 1}× [symbol] ₘ corresponds to a 2^{M}-ary ASK alphabet (which means that m depends on a modulation order). In this case, aᵢ=2i−1, such that a₁=1, a₂=3, . . . , aₘ=2^{M}−1. In one example, for each i, E(aᵢ) may be defined as:

$$E ( {a}_{i} ) = {( 2 i - 1 )}^{2} .$$

In another example, for each i, E(aᵢ) may be defined as:

$$E ( {a}_{i} ) = \frac{i ( i - 1 )}{2} .$$

With these examples, since 8E(aᵢ)+1=(2i−1)², E(aᵢ) may only involve a rescaling of (2i−1)².

The concepts of sequence energy and the parameter N(n, E) may be understood by again, considering an alphabet [symbol] ₘ of size m, and additional a sequence s=(s₁, s₂, . . . , sₙ), where each element in the sequence takes values in [symbol] ₘ. In this case, the energy of the sequence s, denoted by E(s), may be defined as the accumulation (summation), of all the individual symbol energies, for example:

$$E ( s ) = {\sum }_{l = 1}^{n} E ( {s}_{l} ) .$$

The prefix (s₁, s₂, . . . , sₜ) of s may be denoted by s₁^{t} so that the sequence s is also denoted by s₁ⁿ. The energy of the prefix s₁^{t} may be denoted as:

$$E ( {s}_{1}^{t} ) = {\sum }_{l = 1}^{t} E ( {s}_{l} ) .$$

Due to the dependency on the size of the alphabet m, the quantity (total number) of sequences over [symbol] ₘ having length n and energy E may be denoted by N^{[m]}(n, E). If the set of all sequences over alphabet [symbol] ₘ and having length n and energy E is denoted as:

$$\{ s = ( {s}_{1} , {s}_{2} , … , {s}_{n} ) \vert {s}_{i} ∈ { }_{m} , ∀ i , E ( s ) = E \} ,$$

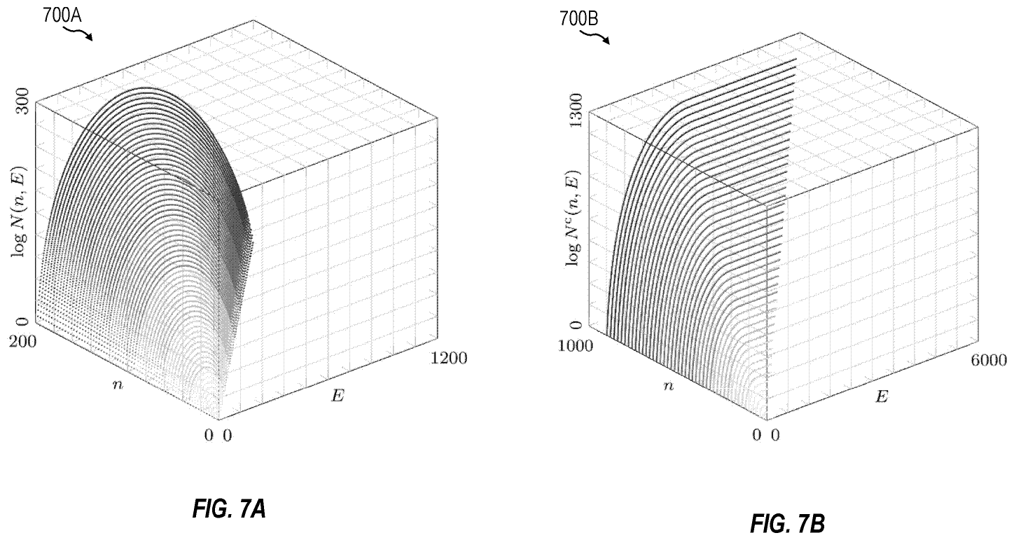

then N^{[m]}(n, E) is the cardinality of this set. When the underlying size m is clear from the context, the m may be dropped and N^{[m]}(n, E) may be written as N(n, E), though it is understood that N(n, E) depends on m, n and E. FIG. 7A shows an example plot of a logarithm of N(n, E) for an example with m=4.

The concept of N_{c}(n, E), where n and E are nonnegative integers, may be understood as follows. Again assuming [symbol] ₘ={a₁, a₂, . . . , aₘ} to be a finite symbol alphabet of size m and that symbol aᵢ has energy Eᵢ=E(aᵢ),

$${N}_{c}^{[ m ]} ( n , E )$$

may denote the number (quantity) of symbol sequences over [symbol] ₘ and each sequence having length n and energy at most equal to E. As with N^{[m]}(n, E), when the underlying size m is clear from the context,

$${N}_{c}^{[ m ]} ( n , E )$$

may be written as N_{c}(n, E).

The relationship between N(n, E) and N_{c}(n, E) may be explained as follows. For every n≥1, N_{c}(n, E) satisfies

$${N}_{c} ( n , E ) = {\sum }_{{E}^{′} = 0}^{E} N ( n , {E}^{′} ) .$$

A convention may dictate that N_{c}(0, E)= [symbol] _{[0,∞)}(E), where [symbol] denotes the indicator function of the set [0, ∞). One example, illustrated in FIG. 7B, considers m=4 and the alphabet [symbol] ₄ is such that E(a₁)=0, E(a₂)=1, E(a₃)=3 and E(a₄)=6. FIG. 7B shows an exact log N_{c}(n, E) with n ranging from 0 to 900.

There are various possible DM schemes that may help enable new algorithmic procedures to realize sphere shaping. For example, one scheme involves (a direct or single step) energy-based arithmetic coding (AC) methods for fixed-to-fixed DM (this scheme may be referred to herein as “direct AC-DM”). A second scheme involves two-step energy-based AC methods for fixed-to-fixed DM (this scheme may be referred to herein as “two-step AC-DM”).

The parameters N(n, E) and N_{c}(n, E) may play roles in the direct AC-DM and two-step AC-DM schemes. For example, direct AC-DM may involve accessing N_{c}(n, E) for a wide range of n and E, as well as a set of typical values of m in each step of AC. Two-step AC-DM may involve accessing N_{c}(n, E) in an energy selection AC step (the first of the two steps) and may also involve accessing N(n, E) in a sequence determination AC step (the second of the two steps). Ideally, both accesses should be made available for a wide range of n and E, as well as a set of typical values of m.

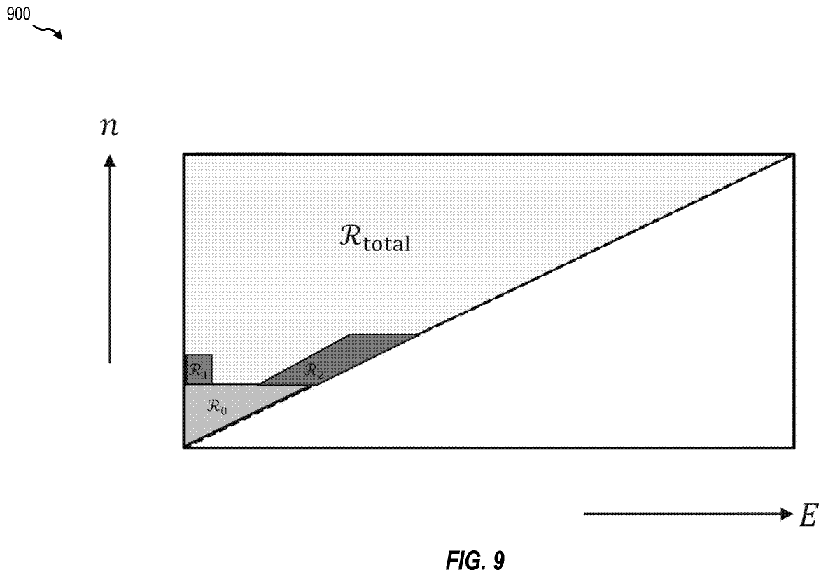

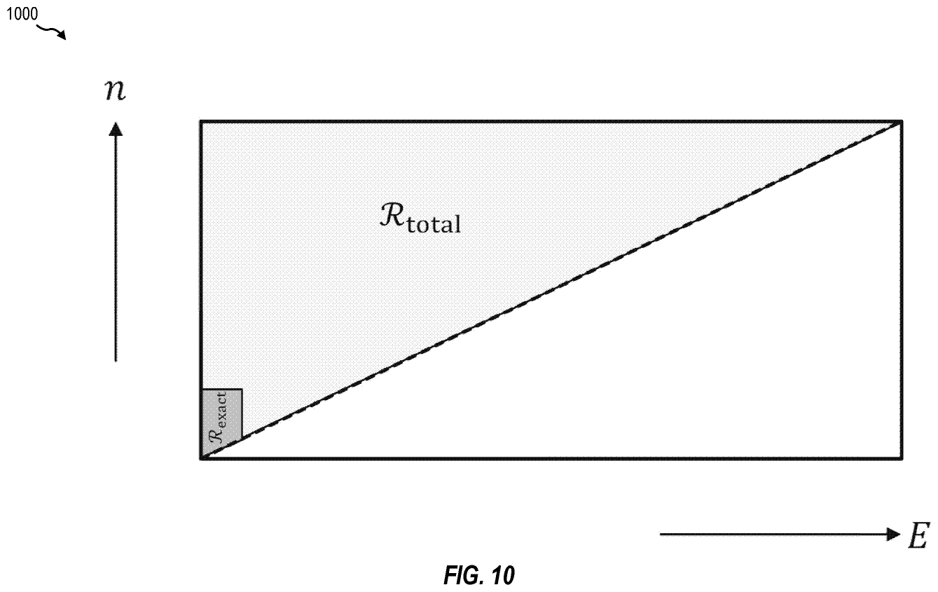

One potential challenge in implementing these schemes is that the approximation precision requirements of N(n, E) and N_{c}(n, E) are typically relatively high. In certain regions of n and E (e.g., “very small n” or “moderate n and very small E”) applying approximation schemes may not render sufficiently high precision for direct AC-DM or two-step AC-DM to achieve desirable (i.e., very small or negligible) performance loss. FIGS. 9 and 10, described below, show examples of such regions.

Due to the numerical inaccuracy of approximations over such regions, it may be preferable to resort to exact values of N(n, E) and N_{c}(n, E). Aspects of the present disclosure provide a mixed (or hybrid) scheme where exact values for N(n, E) and N_{c}(n, E) may be stored and used in such regions, rather than approximations. The exact values may be stored for the relevant regions where applying approximation schemes may not render sufficiently high precision, as well as cases where the approximation schemes may require significantly complex processing.

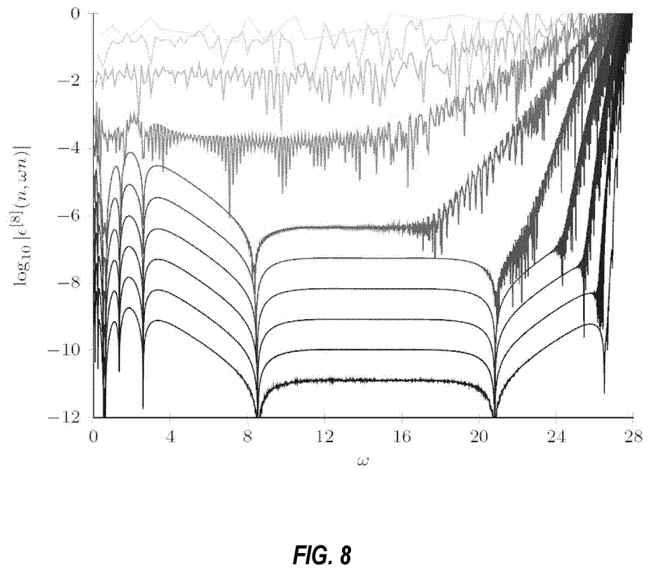

FIG. 8 illustrates an example of the potential numerical inaccuracy caused by approximation error for the case of m=8, for N(n, E). The example assumes application of an example approximation scheme for log N(n, E). For the m=8 case, the resulting approximation log \hat{N}^{[8]}(n, E) of log N^{[8]}(n, E) results in an approximation error below 10⁻³ for all n and E outside of the following regions:

$$\{ ( n , E ) \vert n \geq 401 , E \geq 27.573 n - 348.1 \; 06 \} ;$$

$$\{ ( n , E ) \vert 16 < n \leq 4 \; 00 , E \geq 27.17 n - 202.02 \} ;$$

$$\{ ( n , E ) \vert n \leq 19 , E \leq 6 \} ; and$$

$$\{ ( n , E ) \vert n \leq 16 \} .$$

It may be observed that, in this example, approximation accuracy generally improves as n increases. Even though the above regions cover a wide range of useful regions for the shaping application, they do not cover some regions that may be of interest, such as the “very small n” or the “large E” cases.

Application of the direct AC-DM scheme in accordance with aspects of the present disclosure, may be described as follows. [symbol] (m, n, Ē) may denote the set of all symbol sequences of length n and over [symbol] ₘ, each sequence of which has energy at most equal to Ē. Thus, the cardinality of the set [symbol] (m, n, Ē), meaning the number of sequences in [symbol] (m, n, Ē), may be given by: | [symbol] (m, n, Ē)=N_{c}^{[m]}(n, Ē).

Aspects of the present disclosure may help provide efficient mechanisms to encode (e.g., map) length-k bit sequences into length-n sequences in [symbol] (m, n, Ē) and to help achieve unique decodability.

Based on an input k-bit sequence (the “information bits”), alphabet [symbol] ₘ symbol sequence length n, and maximum energy Ē, the energy-based AC encoding may sequentially determine an output sequence s=(s₁, s₂, . . . , sₙ)∈ [symbol] (m, n, Ē) in n iterations. In this case, the algorithm may initialize parameters as follows: t=0, nₜ=n, Eₜ=Ē and xₜ=x. The algorithm may then iterate t until and including n−1. In each iteration, a single symbol may be determined.

This algorithm may involve accessing (e.g., computing, approximating, or table-looking-up) values for log N_{c}(nₜ−1, Eₜ−E(aᵢ)) for each i∈{1, 2, . . . , m}. In other words, the algorithm may involve accessing log N_{c} “at (nₜ−1, Eₜ−E(aᵢ)).” Based on these plurality of log N_{c} values and the input bit sequence, the algorithm may determine sₜ₊₁. The algorithm may also involve computing a “residual length” nₜ₊₁=nₜ−1 and a “residual maximum energy” Eₜ₊₁=Eₜ−E(sₜ₊₁). The algorithm may then increase t by 1, after completing an iteration t.

Application of the two-step AC-DM scheme, in accordance with aspects of the present disclosure, may be described as follows. As with the direct AC-DM algorithm, aspects of the present disclosure may help provide efficient mechanisms to encode (e.g., map) length-k bit sequences into length-n sequences in [symbol] (m, n, Ē) and to help achieve unique decodability.

Based on an input k-bit sequence (the “information bits”), alphabet [symbol] ₘ, symbol sequence length n, and maximum energy Ē, the two-step AC-DM algorithm may sequentially determine an output sequence s=(s₁, s₂, . . . , sₙ)∈ [symbol] (m, n, Ē) in two steps.

In the first step, the two-step AC-DM algorithm may determine the energy (between 0 and Ē) of the output sequence. This first step may involve accessing log N_{c}(n, E′) with n being the output symbol sequence length and for all E′ between 0 and Ē. Based on the plurality of log N_{c} values and the input bit sequence, the algorithm may then determine the transmission energy E of the output sequence

In the second step, the algorithm may sequentially determine a symbol sequence in [symbol] (m, n, Ē) that has energy equal to the selected number in the first step. This determination may be done in n iterations. For the second step, the algorithm may initialize t=0, nₜ=n, Eₜ=E. The algorithm may then iterate t until and including n−1. In each iteration, a single symbol in the sequence may be determined.

This algorithm may require accessing (e.g., computing or approximating or table-looking-up) log N(nₜ−1, Eₜ−E(aᵢ)) for each i∈{1, 2, . . . , m}. In other words, the algorithm may involve accessing log N “at (nₜ−1, Eₜ−E(aᵢ)).” Based on these plurality of log N values and the input bit sequence, the algorithm may determine sₜ₊₁. The algorithm may also involve computing the “residual length” nₜ₊₁=nₜ−1 and “residual energy” Eₜ₊₁=Eₜ−E(sₜ₊₁). The algorithm may then increase t by 1 after completing an iteration t.

The mixed scheme for determining whether to use approximate or exact values for N and N_{c} may be described as follows. The alphabet [symbol] ₘ of size m and a maximum symbol sequence length nₘₐₓ may be given. The region [symbol] ₜₒₜₐₗ may denote all pairs (n, E) satisfying {(n, E)|0≤n≤nₘₐₓ, 0≤E≤nE(aₘ)}, such that: [symbol] ₜₒₜₐₗ={(n, E)|0≤n≤nₘₐₓ, 0≤E≤nE(aₘ)}. Thus, [symbol] ₜₒₜₐₗ may depend on m and nₘₐₓ.

Access for N according to the mixed scheme proposed herein, in a distribution matcher from the transmitter side or a distribution dematcher from the receiver side, may be as follows. Some form of N(n, E), whether exact or approximate, may be accessed for a ‘generic pair’ of n and E may be required. This may involve the sequential symbol determination steps in the second step of the two-step AC-DM encoding. The proposed mixed approximation scheme for N may be used in such cases, where exact values of N may be used for certain regions (of n, E).

Access for N_{c} according to the mixed scheme proposed herein, in a distribution matcher from the transmitter side or a distribution dematcher from the receiver side, may be as follows. Some form of N_{c}(n, E), exact or approximate, for a ‘generic pair’ of n and E may be required. This access may include the energy determination steps in the first step of the two-step AC-DM encoding and may also include the sequential symbol determination steps in the direct AC-DM encoding. The proposed mixed approximation scheme for N may be used in such cases, where exact values of N_{c} may be used for certain regions (of n, E).

The mixed approximation scheme for N, may involve splitting of [symbol] ₜₒₜₐₗ into separate regions: [symbol] _{exact} and [symbol] ₜₒₜₐₗ\ [symbol] _{exact} for the storage of exact values. For example, for access and evaluation for given n and E, [symbol] ₜₒₜₐₗ may be split into a subset [symbol] _{exact} of [symbol] ₜₒₜₐₗ. The subset [symbol] _{exact} may, for example, correspond to a region (of n, E) that is not amenable to computation approximation schemes (e.g., where approximations are inaccurate or computationally complex). In some cases, exact values may be stored for the entire region (e.g., the subset can be [symbol] ₜₒₜₐₗ).

In some cases, storage of exact values may be done in an efficient manner. For example, some common form of the exact values N(n, E)s for (n, E)∈ [symbol] _{exact} may be stored. When accessing and evaluating whether to access a stored (exact) value or use an approximation for a given n and E, a (set-inclusion relation) comparison on whether (n, E)∈ [symbol] _{exact} or not may be made. For example, if (n, E)∈ [symbol] _{exact}, then the mixed scheme considers the exact value of N(n, E).

For the [symbol] _{exact} region, the stored quantity corresponding to the exact value N(n, E) may be read. The evaluation may potentially involve performing an extra computation, for example, depending on the common form used for the storage. In some cases, if (n, E)∉ [symbol] _{exact}, then the mixed scheme may consider an approximate N(n, E). This evaluation may be based on a computational approximation scheme.

FIG. 9 illustrates one example of how a region [symbol] _{exact} from [symbol] ₜₒₜₐₗ for N could be split into subregions, for the case of m=8. The example may be considered a continuation of the example on numerical inaccuracy illustration in FIG. 8. In the illustrated example, [symbol] _{exact} consists of three subregions [symbol] ₀, [symbol] ₁ and [symbol] ₂ (i.e., [symbol] _{exact}= [symbol] ₀∪ [symbol] ₁∪ [symbol] ₂). Subregion [symbol] ₀ may be defined in the form of {(n, E)|n≤16} and storing exact values in this region may help solve for the inaccuracy of approximation for very small n. Subregion [symbol] ₁ may be defined in the form of {(n, E)|16<n≤19, E≤6} and storing exact values in this region may help solve for the inaccuracy of approximation for small n and very small E. Subregion [symbol] ₂ may be defined in the form of {(n, E)|16<n≤64, E≥27.17n−202.02} and storing exact values in this region may help solve for the inaccuracy of approximation for very large E that are potentially useful for the shaping application.

The exact values for N or N_{c} may be stored in an efficient manner. For example, exact values of N may be stored using a hash-like table for a general region [symbol] _{exact}. In such cases, keys n and E may correspond to a unique index h(n, E) for the table and each entry of the table may be stored in a common form. In some other cases, exact values of N may be stored using a look-up table when [symbol] _{exact} is relatively simple, for example, if [symbol] _{exact}={(n, E)∈ [symbol] ₜₒₜₐₗ|1≤n≤nₜₕᵣₑₛ, 0≤E<Eₜₕᵣₑₛ} for some predetermined nₜₕᵣₑₛ and Eₜₕᵣₑₛ that may depend on m. The size of the table may be nₜₕᵣₑₛ×Eₜₕᵣₑₛ, a row index of the table corresponds to length n and starts indexing from 1, while a column index of the table corresponds to energy E and starts indexing from 1. In some cases, row n and column E may store a common form of N(n, E−1). The common form of exact values may be some functions of the exact values, such as a logarithmic form, log N(n, E), where the base of the log can be a common value (e.g., 2, e or 10). In some cases, the common form may be based on a common shifting and/or common scaling, such as subtracting a common value from all entries or multiplying all entries with a common value. If exact values are stored in such a common form, the corresponding operations may need to be undone upon accessing. In some cases, the precision of exact values may be truncated.

In some cases, a mixed approximation scheme for N_{c} may involve the following. [symbol] ₜₒₜₐₗ may be split into [symbol] _{exact} and [symbol] ₜₒₜₐₗ\ [symbol] _{exact} for storage of exact values. Access and evaluation of N_{c} may be for a given n and E, to decide whether to use an approximation or to retrieve an exact value. A subset [symbol] _{exact} of [symbol] ₜₒₜₐₗ may be chosen by design, for example, where the subset is where N_{c} is not amenable to computation approximation schemes. In some cases, the subset can be [symbol] ₜₒₜₐₗ. In some cases, some common form of the exact values N_{c}(n, E)s for (n, E)∈ [symbol] _{exact} are stored.

For access and evaluation of N_{c}(n, E), given n and E, a (set-inclusion relation) comparison on whether (n, E)∈ [symbol] _{exact} or not may be made. If (n, E)∈ [symbol] _{exact}, then the mixed scheme may consider the exact value of N_{c}(n, E). For access, the stored quantity corresponding to the exact N_{c}(n, E) may be read. For evaluation, a potential extra computation may be performed, depending on the common form used for the storage. If (n, E)∉ [symbol] _{exact}, then the mixed scheme may consider an approximation of N(n, E). The evaluation may be based on a computational approximation scheme.

FIG. 10 illustrates one example of a region [symbol] _{exact} split from [symbol] ₜₒₜₐₗ for N_{c}, for the case of m=8. In this case, an approximation scheme may be applied for log N_{c}(n, E). For the m=8 case, the resulting approximation may result in an approximation error below 10⁻³ for all n and E, except for the very small n and small to moderate E case. Therefore, in the illustrated example, [symbol] _{exact} in this case may be taken as{(n,E)|0<n≤16, E≤100}.

In some cases, exact values of N_{c} may be stored using a hash-like table for a general [symbol] _{exact}. The keys n and E may correspond to the unique index h(n, E) for the table. Each entry of the table can be stored in a common form. In some other cases, exact values of N_{c} may be stored using a look-up table when [symbol] _{exact} is simple, such as when [symbol] _{exact}={(n, E)∈ [symbol] ₜₒₜₐₗ|1≤n≤nₜₕᵣₑₛ, 0≤E<Eₜₕᵣₑₛ} for some predetermined nₜₕᵣₑₛ and Eₜₕᵣₑₛ that may depend on m. The size of the table may be nₜₕᵣₑₛ×Eₜₕᵣₑₛ, where the row index of the table corresponds to length n and starts indexing from 1 and the column index of the table corresponds to energy E and starts indexing from 1. Row n and column E may store (a common form of) N_{c}(n, E−1) and each entry of the table can be stored in a common form.

The common form of exact values for N_{c} may be functions of exact values, such as a logarithmic form, log N_{c}(n, E), where the base of the log can be, e.g., 2, e or 10. In some cases, the common form may be based on a common shifting and/or common scaling, such as subtracting a common value from all entries or multiplying all entries with a common value. In such cases, these functions may need to be undone upon accessing. In some cases, the precision of exact values may be truncated.

### Example Operations of a First Wireless Device

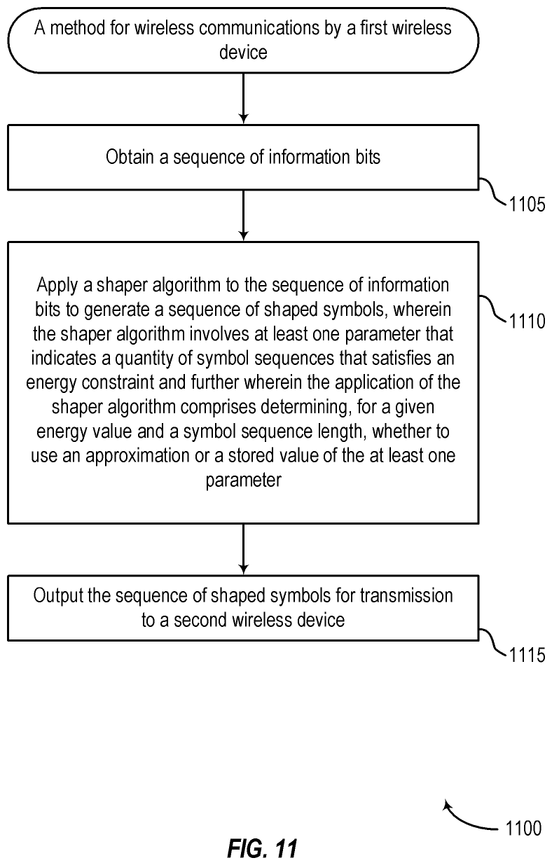

FIG. 11 shows an example of a method 1100 for wireless communications by a transmitter at a first wireless device. In some aspects, the first wireless device is a UE, such as a UE 104 of FIGS. 1 and 3. In some aspects, the first wireless device is a network entity, such as a BS 102 of FIGS. 1 and 3, or a disaggregated base station as discussed with respect to FIG. 2.

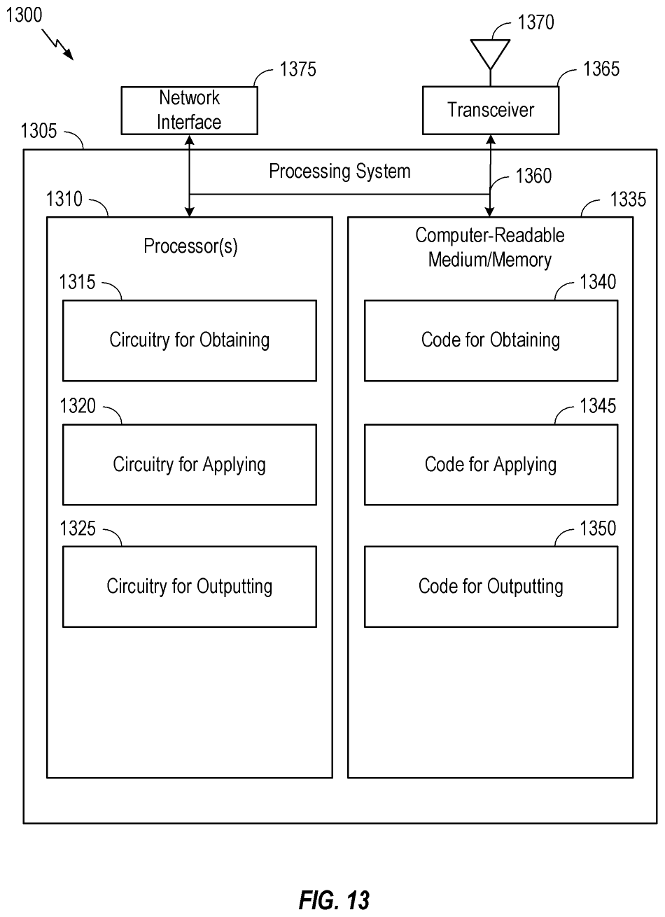

Method 1100 begins at step 1105 with obtaining a sequence of information bits. In some cases, the operations of this step refer to, or may be performed by, circuitry for obtaining and/or code for obtaining as described with reference to FIG. 13.

Method 1100 then proceeds to step 1110 with applying a shaper algorithm to the sequence of information bits to generate a sequence of shaped symbols, wherein the shaper algorithm involves at least one parameter that indicates a quantity of symbol sequences that satisfies an energy constraint and further wherein the application of the shaper algorithm comprises determining, for a given energy value and a symbol sequence length, whether to use an approximation or a stored value of the at least one parameter. In some cases, the operations of this step refer to, or may be performed by, circuitry for generating and/or code for generating as described with reference to FIG. 13.

Method 1100 then proceeds to step 1115 with outputting the sequence of shaped symbols for transmission to a second wireless device. In some cases, the operations of this step refer to, or may be performed by, circuitry for transmitting and/or code for transmitting as described with reference to FIG. 13.

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative steps are possible consistent with this disclosure.

### Example Operations of a Second Wireless Device

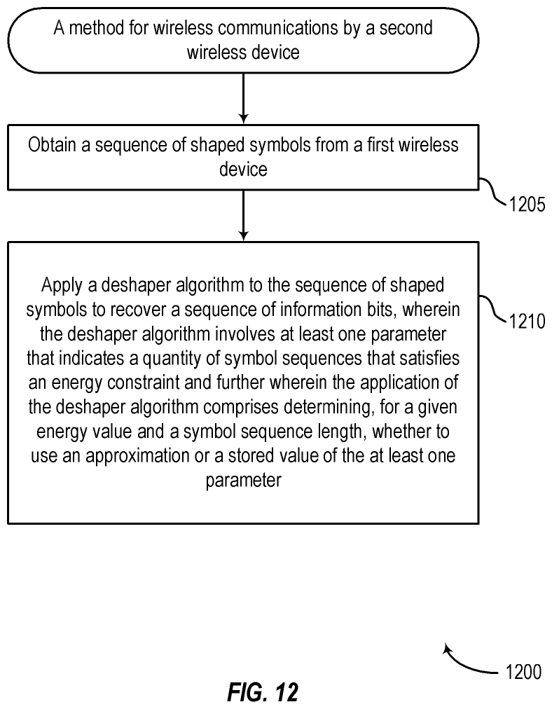

FIG. 12 shows an example of a method 1200 for wireless communications by a receiver at a second wireless device. In some aspects, the second wireless device is a UE, such as a UE 104 of FIGS. 1 and 3. In some aspects, the second wireless device is a network entity, such as a BS 102 of FIGS. 1 and 3, or a disaggregated base station as discussed with respect to FIG. 2.

Method 1200 begins at step 1205 with obtaining a sequence of shaped symbols from a second wireless device. In some cases, the operations of this step refer to, or may be performed by, circuitry for receiving and/or code for receiving as described with reference to FIG. 13.

Method 1200 then proceeds to step 1210 with applying a deshaper algorithm to the sequence of shaped symbols to recover a sequence of information bits, wherein the deshaper algorithm involves at least one parameter that indicates a quantity of symbol sequences that satisfies an energy constraint and further wherein the application of the deshaper algorithm comprises determining, for a given energy value and a symbol sequence length, whether to use an approximation or a stored value of the at least one parameter. In some cases, the operations of this step refer to, or may be performed by, circuitry for identifying and/or code for identifying as described with reference to FIG. 13.

In one aspect, method 1200, or any aspect related to it, may be performed by an apparatus, such as communications device 1300 of FIG. 13, which includes various components operable, configured, or adapted to perform the method 1200. Communications device 1300 is described below in further detail.

Note that FIG. 12 is just one example of a method, and other methods including fewer, additional, or alternative steps are possible consistent with this disclosure.

### Example Communication Device

FIG. 13 depicts aspects of an example communications device 1300. In some aspects, communications device 1300 is a user equipment, such as a UE 104 described above with respect to FIGS. 1 and 3. In some aspects, communications device 1600 is a network entity, such as a BS 102 of FIGS. 1 and 3, or a disaggregated base station as discussed with respect to FIG. 2.

The communications device 1300 includes a processing system 1305 coupled to the transceiver 1365 (e.g., a transmitter and/or a receiver). In some aspects (e.g., when communications device 1300 is a network entity), processing system 1305 may be coupled to a network interface 1375 that is configured to obtain and send signals for the communications device 1300 via communication link(s), such as a backhaul link, midhaul link, and/or fronthaul link as described herein, such as with respect to FIG. 2. The transceiver 1365 is configured to transmit and receive signals for the communications device 1300 via the antenna 1370, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 358, transmit processor 364, TX MIMO processor 366, and/or controller/processor 380, as described with respect to FIG. 3. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1335 via a bus 1360. In certain aspects, the computer-readable medium/memory 1335 is configured to store instructions (e.g., computer-executable code) that when executed by the one or more processors 1310, cause the one or more processors 1310 to perform the method 1100 described with respect to FIG. 11, the method 1100 described with respect to FIG. 11, or any aspect related to it. Note that reference to a processor performing a function of communications device 1300 may include one or more processors 1310 performing that function of communications device 1300.

In the depicted example, computer-readable medium/memory 1335 stores code (e.g., executable instructions), such as code for obtaining 1340, code for applying 1345, and code for outputting 1350 may cause the communications device 1300 to perform the method 1100 described with respect to FIG. 11, the method 1100 described with respect to FIG. 11, or any aspect related thereto.

The one or more processors 1310 include circuitry configured to implement (e.g., execute) the code stored in the computer-readable medium/memory 1335, including circuitry such as circuitry for obtaining 1315, circuitry for applying 1320, and circuitry for outputting 1325 may cause the communications device 1300 to perform the method 1100 described with respect to FIG. 11, the method 1200 described with respect to FIG. 12, or any aspect related thereto.

Various components of the communications device 1300 may provide means for performing the method 1100 described with respect to FIG. 11, the method 1200 described with respect to FIG. 12, or any aspect related thereto. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1365 and the antenna 1370 of the communications device 1300 in FIG. 13. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1365 and the antenna 1370 of the communications device 1300 in FIG. 13. Means for applying, means for determining, and means for storing, means for processing, and means for performing may include one or more of the processors illustrated in FIG. 3.

### Example Clauses

Implementation examples are described in the following numbered clauses:

Clause 1: A method for wireless communications at a first wireless device, comprising: obtaining a sequence of information bits; applying a shaper algorithm to the sequence of information bits to generate a sequence of shaped symbols, wherein the shaper algorithm involves at least one parameter that indicates a quantity of symbol sequences that satisfies an energy constraint and further wherein the application of the shaper algorithm comprises determining, for a given energy value and a symbol sequence length, whether to use an approximation or a stored value of the at least one parameter; and outputting the sequence of shaped symbols for transmission to a second wireless device.

Clause 2: The method of Clause 1, wherein the given energy value is less than or equal to a threshold value.

Clause 3: The method of Clause 1, wherein the symbol sequence length is less than or equal to a length of the generated sequence of shaped symbols.

Clause 4: The method of Clause 1, wherein the at least one parameter indicates a first quantity of symbol sequences, wherein each symbol sequence of the first quantity of symbol sequences: is of the symbol sequence length, includes symbols from a symbol alphabet, and has an energy less than or equal to the given energy value.

Clause 5: The method of Clause 1, wherein the application of the shaper algorithm comprises sequentially determining the shaped symbols of the sequence, wherein each shaped symbol of the sequence is determined in an iteration of multiple iterations of an iterative process.

Clause 6: The method of Clause 4, further comprising: storing, for pairs of symbol sequence lengths and energy values in at least one region, actual values for the first quantity.

Clause 7: The method of Clause 6, wherein the actual values are stored in one or more look-up tables.

Clause 8: The method of Clause 6, wherein the at least one region comprises a sub-region of a larger region, wherein the larger region is defined by a range of symbol sequence lengths and a range of energy values.

Clause 9: The method of Clause 6, wherein the determination, for a given energy value and symbol sequence length, of whether to use an approximation or a stored value of the first quantity is based on whether the given energy value and symbol sequence length are in the at least one region.

Clause 10: The method of Clause 6, wherein: the storing comprises processing the actual values of the first quantity so the actual values of the first quantity are stored using a common form; and the method further comprises performing a computation when retrieving actual values of the first quantity, depending on the common form.

Clause 11: The method of Clause 10, wherein the common form comprises a logarithm of a certain base.

Clause 12: The method of Clause 4, wherein the at least one parameter further indicates a second quantity of symbol sequences, wherein each symbol sequence of the second quantity of symbol sequences: is of the symbol sequence length, includes symbols from a symbol alphabet, and has an energy equal to the given energy value.

Clause 13: The method of Clause 12, wherein applying the shaper algorithm comprises: an energy determining step that involves the first quantity of symbol sequences; and a symbol sequence determining step that involves the second quantity of symbol sequences.

Clause 14: The method of Clause 13, wherein the symbol sequence determining step involves sequentially determining shaped symbols of the sequence in a number of iterations, to find a sequence of symbols that has an energy determined in the energy determining step.

Clause 15: The method of Clause 12, further comprising: storing, for pairs of symbol sequence lengths and energy values in at least one region, actual values for the second quantity.

Clause 16: The method of Clause 15, wherein the actual values are stored in one or more look-up tables.

Clause 17: The method of Clause 15, wherein the at least one region comprises a sub-region of a larger region, wherein the larger region is defined by a range of symbol sequence lengths and a range of energy values.

Clause 18: The method of Clause 15, wherein the determination, for a given energy value and symbol sequence length, of whether to use an approximation or a stored value of the second quantity when applying the shaper algorithm is based on whether the given energy value and symbol sequence length is in the at least one region.

Clause 19: The method of Clause 15, wherein: the storing comprises processing the actual values of the second quantity so the actual values of the second quantity are stored using a common form; and the method further comprises performing a computation when retrieving actual values of the second quantity, depending on the common form.

Clause 20: The method of Clause 19, wherein the common form comprises a logarithm of a certain base.

Clause 21: A method for wireless communications at a second wireless device, comprising: obtaining a sequence of shaped symbols from a first wireless device; and applying a deshaper algorithm to the sequence of shaped symbols to recover a sequence of information bits, wherein the deshaper algorithm involves at least one parameter that indicates a quantity of symbol sequences that satisfies an energy constraint and further wherein the application of the deshaper algorithm comprises determining, for a given energy value and a symbol sequence length, whether to use an approximation or a stored value of the at least one parameter.

Clause 22: The method of Clause 21, wherein the given energy value is less than or equal to a threshold value.

Clause 23: The method of Clause 21, wherein the symbol sequence length is less than or equal to a length of the generated sequence of shaped symbols.

Clause 24: The method of Clause 21, wherein the at least one parameter indicates a first quantity of symbol sequences, wherein each symbol sequence of the first quantity of symbol sequences: is of the symbol sequence length, includes symbols from a symbol alphabet, and has an energy less than or equal to the given energy value.

Clause 25: The method of Clause 21, wherein the application of the deshaper algorithm comprises sequentially determining sets of bits from the shaped symbols of the sequence, wherein each set of bits is determined in an iteration of multiple iterations of an iterative process.

Clause 26: The method of Clause 24, further comprising: storing, for pairs of symbol sequence lengths and energy values in at least one region, actual values for the first quantity.

Clause 27: The method of Clause 26, wherein the actual values are stored in one or more look-up tables.

Clause 28: The method of Clause 26, wherein the at least one region comprises a sub-region of a larger region, wherein the larger region is defined by a range of symbol sequence lengths and a range of energy values.

Clause 29: The method of Clause 26, wherein the determination, for a given energy value and symbol sequence length, of whether to use an approximation or a stored value of the first quantity is based on whether the given energy value and symbol sequence length are in the at least one region.

Clause 30: The method of Clause 26, wherein: the storing comprises processing the actual values of the first quantity so the actual values of the first quantity are stored using a common form; and the method further comprises performing a computation when retrieving actual values of the first quantity, depending on the common form.

Clause 31: The method of Clause 30, wherein the common form comprises a logarithm of a certain base.

Clause 32: The method of Clause 24, wherein the at least one parameter further indicates a second quantity of symbol sequences, wherein each symbol sequence of the second quantity of symbol sequences: is of the symbol sequence length, includes symbols from a symbol alphabet, and has an energy equal to the given energy value.

Clause 33: The method of Clause 32, wherein applying the deshaper algorithm comprises: an energy determining step that involves the first quantity of symbol sequences; and a symbol sequence determining step that involves the second quantity of symbol sequences.

Clause 34: The method of Clause 33, wherein the symbol sequence determining step involves sequentially determining shaped symbols of the sequence in a number of iterations, to find a sequence of symbols that has an energy determined in the energy determining step.

Clause 35: The method of Clause 32, further comprising: storing, for pairs of symbol sequence lengths and energy values in at least one region, actual values for the second quantity.

Clause 36: The method of Clause 35, wherein the actual values are stored in one or more look-up tables.

Clause 37: The method of Clause 35, wherein the at least one region comprises a sub-region of a larger region, wherein the larger region is defined by a range of symbol sequence lengths and a range of energy values.

Clause 38: The method of Clause 35, wherein the determination, for a given energy value and symbol sequence length, of whether to use an approximation or a stored value of the second quantity when applying the shaper algorithm is based on whether the given energy value and symbol sequence length is in the at least one region.

Clause 39: The method of Clause 35, wherein: the storing comprises processing the actual values of the second quantity so the actual values of the second quantity are stored using a common form; and the method further comprises performing a computation when retrieving actual values of the second quantity, depending on the common form.

Clause 40: The method of Clause 39, wherein the common form comprises a logarithm of a certain base.

Clause 41: An apparatus, comprising: a memory comprising executable instructions; and a processor configured to execute the executable instructions and cause the apparatus to perform a method in accordance with any one of Clauses 1-40.

Clause 42: An apparatus, comprising means for performing a method in accordance with any one of Clauses 1-40.

Clause 43: A non-transitory computer-readable medium comprising executable instructions that, when executed by a processor of an apparatus, cause the apparatus to perform a method in accordance with any one of Clauses 1-40.

Clause 44: A computer program product embodied on a computer-readable storage medium comprising code for performing a method in accordance with any one of Clauses 1-40.

Clause 45: A wireless device, comprising: at least one transceiver; a memory comprising instructions; and one or more processors configured to execute the instructions and cause the wireless device to perform a method in accordance with any one of Clauses 1-20, wherein the at least one transceiver is configured to transmit the sequence of symbols.

Clause 46: A wireless device, comprising: at least one transceiver; a memory comprising instructions; and one or more processors configured to execute the instructions and cause the wireless device to perform a method in accordance with any one of Clauses 21-40, wherein the at least one transceiver is configured to receive the sequence of symbols.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus comprising: a memory comprising processor-executable instructions; and one or more processors configured to execute the processor-executable instructions and cause the apparatus to:
obtain a sequence of information bits;
apply a shaper algorithm to the sequence of information bits to generate a sequence of shaped symbols, wherein the shaper algorithm involves at least one parameter that indicates a quantity of symbol sequences that satisfies an energy constraint and further wherein the application of the shaper algorithm comprises determining, for a given energy value and a symbol sequence length, whether to use an approximation or a stored value of the at least one parameter; and
output the sequence of shaped symbols for transmission.

2. The apparatus of claim 1, wherein the given energy value is less than or equal to a threshold value.

3. The apparatus of claim 1, wherein the symbol sequence length is less than or equal to a length of the generated sequence of shaped symbols.

4. The apparatus of claim 1, wherein the at least one parameter indicates a first quantity of symbol sequences, wherein each symbol sequence of the first quantity of symbol sequences:
is of the symbol sequence length,
includes symbols from a symbol alphabet, and
has an energy less than or equal to the given energy value.

5. The apparatus of claim 1, wherein the application of the shaper algorithm comprises sequentially determining the shaped symbols of the sequence, wherein each shaped symbol of the sequence is determined in an iteration of multiple iterations of an iterative process.

6. The apparatus of claim 4, wherein the one or more processors are configured to execute the processor-executable instructions and cause the apparatus to:
store, for pairs of symbol sequence lengths and energy values in at least one region, actual values for the first quantity.

7. The apparatus of claim 6, wherein the actual values are stored in one or more look-up tables.

8. The apparatus of claim 6, wherein the at least one region comprises a sub-region of a larger region, wherein the larger region is defined by a range of symbol sequence lengths and a range of energy values.

9. The apparatus of claim 6, wherein the determination, for a given energy value and symbol sequence length, of whether to use an approximation or a stored value of the first quantity is based on whether the given energy value and symbol sequence length are in the at least one region.

10. The apparatus of claim 6, wherein:
the storing comprises processing the actual values of the first quantity so the actual values of the first quantity are stored using a common form; and
the method further comprises performing a computation when retrieving actual values of the first quantity, depending on the common form.

11. The apparatus of claim 10, wherein the common form comprises a logarithm of a certain base.

12. The apparatus of claim 4, wherein the at least one parameter further indicates a second quantity of symbol sequences, wherein each symbol sequence of the second quantity of symbol sequences:
is of the symbol sequence length,
includes symbols from a symbol alphabet, and
has an energy equal to the given energy value.

13. The apparatus of claim 12, wherein applying the shaper algorithm comprises:
an energy determining step that involves the first quantity of symbol sequences; and
a symbol sequence determining step that involves the second quantity of symbol sequences.

14. The apparatus of claim 13, wherein the symbol sequence determining step involves sequentially determining shaped symbols of the sequence in a number of iterations, to find a sequence of symbols that has an energy determined in the energy determining step.

15. The apparatus of claim 12, wherein the one or more processors are configured to execute the processor-executable instructions and cause the apparatus to:
store, for pairs of symbol sequence lengths and energy values in at least one region, actual values for the second quantity.

16. The apparatus of claim 15, wherein the actual values are stored in one or more look-up tables.

17. The apparatus of claim 15, wherein the at least one region comprises a sub-region of a larger region, wherein the larger region is defined by a range of symbol sequence lengths and a range of energy values.

18. The apparatus of claim 15, wherein the determination, for a given energy value and symbol sequence length, of whether to use an approximation or a stored value of the second quantity when applying the shaper algorithm is based on whether the given energy value and symbol sequence length is in the at least one region.

19. The apparatus of claim 15, wherein:
the storing comprises processing the actual values of the second quantity so the actual values of the second quantity are stored using a common form; and
the method further comprises performing a computation when retrieving actual values of the second quantity, depending on the common form.

20. The apparatus of claim 19, wherein the common form comprises a logarithm of a certain base.

21. An apparatus comprising: a memory comprising processor-executable instructions; and one or more processors configured to execute the processor-executable instructions and cause the apparatus to:
obtain a sequence of shaped symbols; and
apply a deshaper algorithm to the sequence of shaped symbols to recover a sequence of information bits, wherein the deshaper algorithm involves at least one parameter that indicates a quantity of symbol sequences that satisfies an energy constraint and further wherein the application of the deshaper algorithm comprises determining, for a given energy value and a symbol sequence length, whether to use an approximation or a stored value of the at least one parameter.

22. The apparatus of claim 21, wherein the given energy value is less than or equal to a threshold value.

23. The apparatus of claim 21, wherein the symbol sequence length is less than or equal to a length of the generated sequence of shaped symbols.

24. The apparatus of claim 21, wherein the at least one parameter indicates a first quantity of symbol sequences, wherein each symbol sequence of the first quantity of symbol sequences:
is of the symbol sequence length,
includes symbols from a symbol alphabet, and
has an energy less than or equal to the given energy value.

25. The apparatus of claim 21, wherein the application of the deshaper algorithm comprises sequentially determining sets of bits from the shaped symbols of the sequence, wherein each set of bits is determined in an iteration of multiple iterations of an iterative process.

26. The apparatus of claim 24, wherein the one or more processors are configured to execute the processor-executable instructions and cause the apparatus to:
store, for pairs of symbol sequence lengths and energy values in at least one region, actual values for the first quantity.

27. The apparatus of claim 26, wherein the actual values are stored in one or more look-up tables.

28. The apparatus of claim 26, wherein the at least one region comprises a sub-region of a larger region, wherein the larger region is defined by a range of symbol sequence lengths and a range of energy values.

29. The apparatus of claim 26, wherein the determination, for a given energy value and symbol sequence length, of whether to use an approximation or a stored value of the first quantity is based on whether the given energy value and symbol sequence length are in the at least one region.

30. A user equipment (UE) comprising: a transceiver, a memory comprising processor-executable instructions, and one or more processors configured to execute the processor-executable instructions and cause the UE to:
obtain a sequence of information bits;
apply a shaper algorithm to the sequence of information bits to generate a sequence of shaped symbols, wherein the shaper algorithm involves at least one parameter that indicates a quantity of symbol sequences that satisfies an energy constraint and further wherein the application of the shaper algorithm comprises determining, for a given energy value and a symbol sequence length, whether to use an approximation or a stored value of the at least one parameter; and
transmit, via the transceiver, the sequence of shaped symbols.
